(19) United States
(12) Patent Application Publication
(10) Pub. No.: US 2007/0029375 A1
(43) Pub. Date: Feb. 8, 2007

(54) System and method for transferring funds from a first to a second individual for access using a stored value card

(75) Inventor: Randy Hines, Oceanside, CA (US)

Correspondence Address: Matthew K. Hillman, 2207 Recodo Ct., Carlsbad, CA, 92009, US

(73) Assignee: WMO Global, Encinitas, CA (US)

(21) Appl. No.: 11/197,824

(22) Filed: Aug. 5, 2005

(51) Int. Cl. G07F 19/00; G06K 5/00; G06Q 40/00

(52) U.S. Cl. 235/379; 235/380; 705/41

(57) ABSTRACT

Systems and methods are disclosed for the monetary transfer of funds from a first individual to a second individual. Transfers may include the acts or steps of providing the second individual with a Receiver Access Card; gathering information about the second individual and the identity of the first individual from the second individual; and delivering a Sender Access Card and information identifying the second individual to the first individual. The transfer may also include the acts or steps of receiving a request from the first individual to activate the Sender Access Card; allowing the first individual to load the card with funds; and processing a request by the first individual to designate a portion of the funds to be made available for use by the second individual. In one implementation, the transfer may be completed by allowing the second individual to access the available funds with the Receiver Access Card.

### FIELD OF THE INVENTION

The present invention relates to methods for transferring funds between individuals. The present invention is particularly, but not exclusively useful for transferring funds from a first individual to a second individual for subsequent access using a stored value card.

### BACKGROUND OF THE INVENTION

For a variety of reasons, a large percentage of the population, even in developed nations, is either un-banked or under-banked, and as a consequence, these individuals may not have access to standard banking vehicles such as checking accounts, credit cards or bank issued ATM cards. Indeed, many of these individuals lack valid identification, lack a stable residential address, have an insufficient knowledge of the banking system and/or have a poor credit history or no credit history. Cultural and language barriers can also aggravate the ability of certain individuals from enjoying the convenient and relatively low cost banking options that many others take for granted. Examples of under-banked individuals include immigrants, young people including college students and military personnel.

Once these individuals have been shunned by mainstream banking institutions, they generally fall victim to predatory practices. In particular, these individuals often must pay outrageous amounts to cash paychecks at specialized check cashing centers, often carry or hold unsafe amounts of currency, and must expend an enormous amount of time, money and energy to pay simple bills or transfer money to a family member or friend.

Still, in spite of the hurdles described above, un-banked and under-banked individuals transfer a huge amount of money to family members and friends. In fact, recent statistics indicate that over $16 billion per year is being transferred from the United States to individuals in Mexico and that only about 3% of these transactions are handled through conventional banking accounts. The remaining 97% of these transfers are either handled by wire transfer companies, special money transfer agents or are delivered in-person or via courier as hard currency. Unfortunately, these currently available money transfer systems are inconvenient for both the sender and recipient, typically include harsh transfer fees, and often subject the transferor to non-market exchange rates.

With the above considerations in mind, Applicants disclose systems and methods for conveniently and economically transferring funds from a first to a second individual for subsequent access using a stored value card.

### SUMMARY OF THE INVENTION

The present invention is directed to both systems and methods for monetary transfer of funds between individuals. In a first aspect, a monetary transfer of funds from a first individual to a second individual may include the acts or steps of providing a Sender Access Card and information identifying the second individual to the first individual; and thereafter activating the Sender Access Card in response to a request from the first individual to allow the first individual to load the card with funds and designate a portion of the funds to be made available for use by the second individual.

In another aspect, the monetary transfer of funds from a first individual to a second individual may include the acts or steps of providing the second individual with a Receiver Access Card; gathering information about the second individual and the identity of the first individual from the second individual; and delivering a Sender Access Card and information identifying the second individual to the first individual. The transfer may also include the acts or steps of receiving a request from the first individual to activate the Sender Access Card; allowing the first individual to load the card with funds; and processing a request by the first individual to designate a portion of the funds to be made available for use by the second individual. In one implementation, the transfer may be completed by allowing the second individual to access the available funds with the Receiver Access Card.

In yet another aspect, the monetary transfer of funds to a second individual from a first individual may include the acts or steps of providing the second individual with a Receiver Access Card; gathering information about the second individual and the identity of the first individual from the second individual; and establishing an account for the first individual. The transfer may also include the acts or steps of designating a portion of funds in the account to be made available for use by the second individual; and allowing the second individual to access the available funds with the Receiver Access Card.

### BRIEF DESCRIPTION OF THE DRAWINGS

FIG. 1 shows a flow diagram illustrating a method for transferring funds from a first to a second individual for subsequent access using a stored value card;

FIG. 2 shows a schematic diagram illustrating the commingling of funds from a plurality of individuals having Sender Access Cards in a single common pool; and

FIG. 3 shows a schematic diagram illustrating that an individual having a Sender Access Card may allocate several portions of their account to be available to more than one recipient.

### DETAILED DESCRIPTION OF PREFERRED EMBODIMENTS

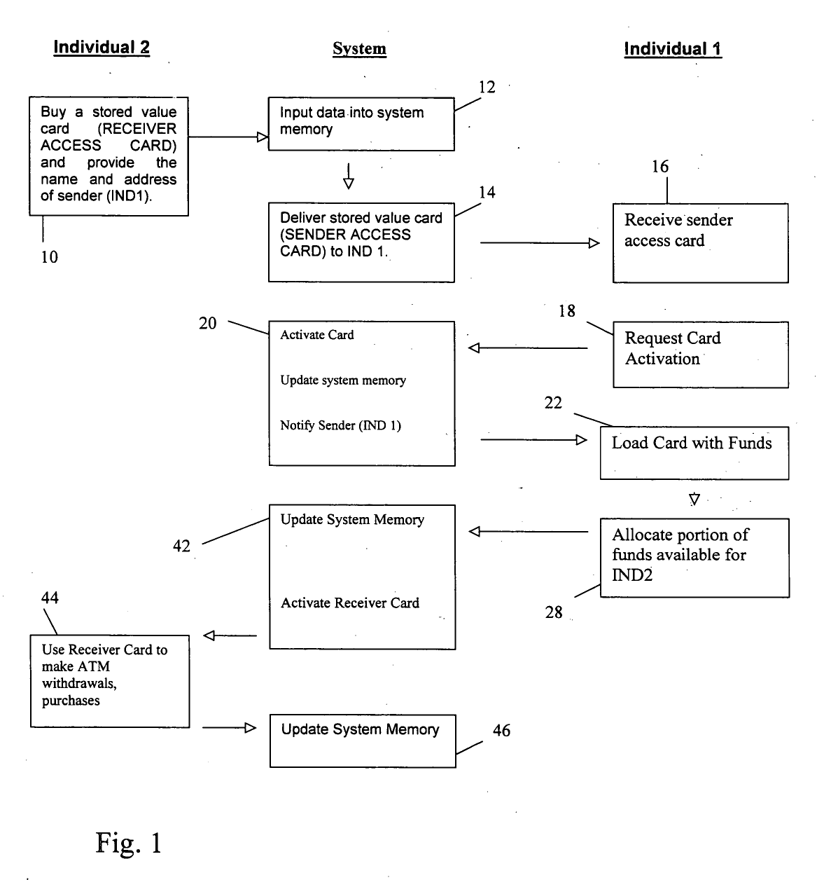

With initial reference to FIG. 1, a flow diagram illustrating a method for transferring funds from a first individual (IND 1) to a second individual (IND 2) is shown. As shown in box 10, the method may include the act of providing a Receiver Access Card to the second individual. In one implementation of the present methods, the Receiver Access Card is a so-called stored value card. As used herein, the term “stored value card” and its derivatives means a card which represents funds on deposit with the card issuer. For this purpose, the stored value card may be issued in the name of an individual and designed for use solely by that individual, or may be anonymous and designed for use by anyone possessing the card.

For the present methods, the stored value card may be, but is not necessarily limited to, a so-called smart card, a memory card, or what is hereinafter referred to as a bearer card. Typically, a smart card includes integrated circuitry including a microprocessor (e.g. chip) that is embedded into a flat, plastic body. On the other hand, memory cards are generally less sophisticated and contain only non-volatile memory storage components, and in some cases, some specific security logic. For example, a memory card may have a magnetic swipe strip that is encoded with an account number allowing the account number to be accessed using a terminal, reader or the like. Alternatively, the stored value card may merely bear an account number (i.e. bearer card). This can be in the form of raised characters allowing for a card imprint, printed characters allowing an account number to be input by the user, merchant, bank teller, etc. on a system peripheral, e.g., PINpad, website, automatic phone system, etc. Alternatively, or in addition thereto, the card may contain a bar-code or other two dimension symbol representing an account number allowing the account number to be accessed by scanning the card with an optical reader. Other card variations which include RFID technology may also be used. Of course, the card may include more than one of the features described above, e.g. a magnetic swipe strip and raised characters. Other features of the card may include an emblem or logo, e.g. Maestro®, Visa®, Cirrus®, Futura™ or the like, indicating that the card is part of an access program and is eligible for use at participating ATM's, retail stores, websites and the like.

Box 10 further indicates that the name and a mailing address of the second individual is obtained from the first individual. For example, the Receiver Access Card may be sold to the second individual at a retail store, grocery store, pharmacy, convenience store, etc., at which point the second individual may receive a form requesting the first individual's information. Alternatively, the card may be given to the second individual (free of charge), may be coupled with other goods or services, may be given as part of a promotional scheme, or may be given or sold to the first individual for subsequent delivery to the second individual. In still other implementations, a fee may be charged at the time of activation, the time of use, and/or at the time of card delivery.

If used, the information request form may be filled out and submitted to a store clerk, teller, etc. or mailed, faxed or otherwise delivered to an appropriate system provider address. Alternatively, the second individual may provide the first individual's information to the system provider verbally over the phone (e.g. to a live operator or automated recording device) or the information may be input at a system provider website. For the present methods, the first individual's information (e.g. name, address and in some cases phone number) may be provided before the first individual receives the card, contemporaneously with the first individual receiving the card, or after the first individual receives the card.

Continuing with FIG. 1, it can be seen that information regarding the second individual (if applicable) and the information provided regarding the first individual (e.g. name and mailing address) is input into system memory (box 12). Typically, this act is performed by an electronic system architecture that is in whole or in part established and maintained by a system provider and which may include one or more computers, e.g. mainframes, servers, pc's, or a network containing two or more computers, e.g. mainframes, servers, pc's. For example, the electronic system architecture may have one or more database structures and may include one or more processors for performing instructions that are stored or carried on one or more machine readable media or input through one or more computer peripherals (readers, terminals, touch-screens, PINpads, keyboards, etc). Suitable processors include, but are not limited to, programmed general purpose digital computers, microprocessors, digital signal processors (DSP), integrated circuits, application specific integrated circuits (ASIC's), logic gate arrays and switching arrays.

Suitable machine readable media include, but are not limited to, RAM, disk drives, optical discs such as a compact disk (CD), CD-ROM, CD-R (a recordable CD-ROM that can be read on a CD-ROM drive), CD-RW (multiple-write CD), CD-E (recordable and erasable CD), or DVD (digital video disc). Alternatively, instead of, or in addition to an optical disc, the machine readable media can include one or more of the following: a magnetic data storage diskett (floppy disk), a Zip disk, DASD storage (e.g., a conventional “hard drive” or a RAID array), magnetic tape, RAM, electronic read-only memory (e.g., ROM, EPROM, or EEPROM), paper punch cards, or transmission media such as digital and/or analog communication links.

Box 14 of FIG. 1 shows that once the data is input into system memory, the system can initiate the delivery of a Sender Access Card to the first individual. This delivery may be by regular mail, common carrier, or any other type of delivery service known in the pertinent art. Typically, information identifying the second individual and indicating how the first individual may activate and use the card is also delivered to the first individual along with the card. For the present methods, the card delivered to the first individual is typically a stored value card as described above.

Upon receipt of the Sender Access Card (box 16) and instructions, if any, the first individual may be required to request that the system provider activate the card prior to use (box 18). Request for card activation may be accomplished in one of several ways. For example, the system may provide an architecture wherein the first individual is able to activate the card verbally, over the phone, (to a live operator or menu-driven, automated recording device). Alternatively, or in addition to phone activation, the system may provide for the first individual to fax, mail, present, e.g. at a participating retail store, bank, etc., deliver a completed request for activation form to the system provider and/or the system may provide for the card to be activated by the first individual at a system provider website.

Box 20 of FIG. 1 shows that upon suitable request, the system may activate the card, update system memory to reflect card activation and any other information gathered from the first individual and, in some cases, notify the first individual of the activation. Once activated, the first individual, may load funds (box 22), use the Sender Access Card to make ATM transactions including withdrawals and transfers, purchases at participating retailers, as well as so-called “card not present” transactions such as Internet transactions including purchases, telephone transactions including purchase and/or mail order purchases.

Loading of funds on the Sender Access Card (box 22) may be accomplished in one of several ways. For example, the system may provide an architecture in which the first individual is able to make an electronic transfer of funds from another account to the Sender Access Card. This transaction may be initiated verbally, over the phone, (e.g. to a live operator or menu-driven, automated recording device) or at a system provider website. Alternatively, or in addition to a sender initiated electronic transfer, the system may provide for the first individual to tender currency at a participating retail store, bank, etc. to load the Sender Access Card. For example, the system architecture may provide for the participating retail store to electronically transfer funds from the participating retail store's account to the System account (e.g. system general pool discussed below) upon reciept of currency from the first individual. Another option for loading the card is for the first individual to initiate a so-called direct deposit transfer, e.g. a periodic, repeating payroll transfer from their employer, or from some other income stream.

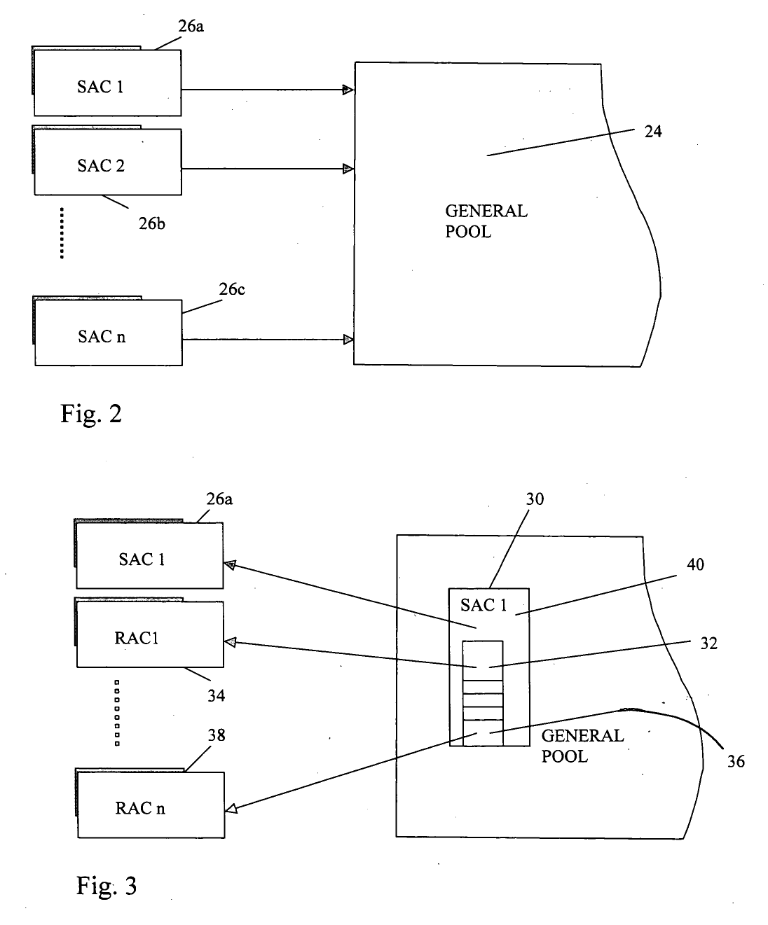

As best seen in FIG. 2, in one implentation of the present methods, transfers of funds to the system provider that result from card loading are accumulated in a general pool 24. As shown, funds from several individuals, each having having an activated Sender Access Card (SAC1 (block 26a), SAC2 (block 26b). . . SACn (block 26c)) are comingled in the general pool 24. For this particular embodiment, the electronic system architecture (see description above) may track the portion of the general pool corresponding to a particular Sender Access Card.

Referring back to FIG. 1, it can be seen that once the Sender Access Card has been loaded with funds (box 22), the first individual may allocate a portion (i.e. some or all) of the deposited funds to be available to the second individual (box 28). Moreover, in some implementations, as shown in FIG. 3, the first individual may allocate several portions of their account to be available to more than one recipient, respectively. As shown there, the portion of the general pool 24 belonging to the first individual (i.e. portion 30 corresponding to SAC 1 balance) may be subdivided and allocated to several individuals (i.e. n individuals) having Receiver Access Cards. More specifically, for the example shown in FIG. 3, the first individual has allocated a first portion 32 of their SAC 1 balance to be available to Receiver Access Card I (block 34) and has allocated a second portion 36 of their SAC 1 balance to be available to Receiver Access Card n (block 38). As shown, the remaining, unallocated portion 40 of the SAC 1 balance is available to the first individual's Sender Access Card.

FIG. 1 further shows that after the first individual has loaded the Sender Access Card and allocated a portion of the funds to be available the second individual (boxes 22 and 28), the system memory of the electronic system architecture is updated (box 42) and the Receiver Access Card is activated. Once the Receiver Access Card is activated, the second individual can use the card (box 44) to make one or more of the following transactions; ATM transactions including withdrawals and transfers, purchases at participating retailers, and so-called “card not present” transactions such as Internet transactions including purchases, telephone transactions including purchases and/or mail order purchases. Moreover, the electronic system architecture may allow the second individual to obtain balance information, transaction history, or other account information by phone (verbally or using telephone keypad to a live operator or automated recording device) or the information may be obtained at a system provider website or system affiliated ATM. For each such transaction, the system memory of the electronic system architecture is updated (box 46). Once the Sender Access Card and Reciever Access Cards are activated, system transactions (i.e. boxes 22, 28 and 44) may be completed as desired by the first and second individuals, until the account is cancelled by the first individual.

In another aspect, the present methods may include the act of selecting a first geographic area that is characterized by a first per capita income demographic. The method may then include distributing Receiver Access Cards in the first geographic area. A system architecture may be established to provide specific transactions (i.e. box 44) for individuals having Receiver access cards in the first geographic area. The act of distribution can include advertising to individuals in the first geographic area and displaying/selling of Receiver Access Cards at retail locations in the first geographic area. These methods may also include the act of selecting a second geographic area that is characterized by a second per capita income demographic, with the second per capita income being greater than the first per capita income. A system architecture may be established to provide specific transactions (i.e. box 44) for individuals having Sender Access Cards in the second geographic area. For example, a system architecture may be provided to activate and load Sender Access Cards including direct deposit transfers to the Sender Access Cards. In some implementations, the first geographical area may be in a first country, e.g. Mexico, while the second geographical area may be in a second country, e.g. the United States of America.

While the particular Systems and Methods for Transferring Funds From a First to a Second Individual for access using a Stored Value Card as herein shown and described in detail are fully capable of attaining the above-described objects of the invention, it is to be understood that they are the presently preferred embodiments of the present invention and are thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a system or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”.

what is claimed is:

1. A method for monetary transfer of funds from a first individual to a second individual, said method comprising the acts of:
providing a sender access card and information identifying said second individual to said first individual; and thereafter
activating said sender access card in response to a request from said first individual, said card activation allowing said first individual to load said card with funds and designate a portion of said funds to be made available for use by said second individual.

2. A method as recited in claim I further comprising the act of:
providing said second individual with a receiver access card to access said available funds.

3. A method as recited in claim 2 further comprising the act of:
collecting information about said second individual and the identity of said first individual from said second individual at the time the receiver access card is provided to said second individual.

4. A method as recited in claim 2 wherein said receiver access card is sold to said second individual.

5. A method as recited in claim I wherein said funds are made available to said second individual for access with a stored value card.

6. A method as recited in claim I wherein said sender access card is a stored value card.

7. A method as recited in claim I wherein said sender access card is loaded by effectuating a direct deposit payroll transfer.

8. A method as recited in claim 1 wherein said sender access card is loaded by accepting currency tendered by said first individual.

9. A method as recited in claim 1 wherein said portion is less than one-hundred percent of funds available to said second individual.

10. A method as recited in claim 1 wherein said request from said first individual is received over a phone line.

11. A method as recited in claim 1 wherein said request from said first individual is received by an internet server.

12. A method for monetary transfer of funds from a first individual to a second individual, said method comprising the steps of:
providing said second individual with a receiver access card;
gathering information about said second individual and the identity of said first individual from said second individual;
delivering a sender access card and information identifying said second individual to said first individual;
receiving a request from said first individual to activate said sender access card;
allowing said first individual to load said card with funds;
processing a request by said first individual to designate a portion of said funds to be made available for use by said second individual; and
allowing said second individual to access said available funds with said receiver access card.

13. A method as recited in claim 12 further comprising the steps of:
selecting a first geographic area that is characterized by a first per capita income demographic, and wherein said second individual is provided with said receiver access card in said first geographic area; and
selecting a second geographic area that is characterized by a second per capita income demographic, with the second per capita income being greater than the first per capita income, and wherein said sender access card is delivered to said first individual in said second geographic area.

14. A method as recited in claim 13 wherein said receiver access card is sold to said second individual at a retail location in the first geographic area.

15. A method as recited in claim 12 wherein said portion is less than one-hundred percent of funds available to said second individual.

16. A method for monetary transfer of funds to a second individual from a first individual, said method comprising the act of:
providing said second individual with a receiver access card;
gathering information about said second individual and the identity of said first individual from said second individual;
establishing an account for said first individual;
designating a portion of funds in said account to be made available for use by said second individual; and
allowing said second individual to access said available funds with said receiver access card.

17. A method as recited in claim 16 wherein said receiver access card is sold to said second individual.

18. A method as recited in claim 17 wherein said receiver access card is sold to said second individual at a retail location.

19. A method as recited in claim 16 wherein said receiver access card is a stored value card.

20. A method as recited in claim 16 wherein said portion is less than one-hundred percent of funds available to said second individual.
